(19) United States
(12) Patent Application Publication
(10) Pub. No.: US 2019/0360529 A1
(43) Pub. Date: Nov. 28, 2019

(54) TWIN TANDEM WHEEL BEARING WITH COMPACT TANDEM ARRANGEMENT

(71) Applicant: SCHAEFFLER TECHNOLOGIES AG & CO. KG, Herzogenaurach (DE)

(72) Inventors: Alaa Makke, Farmington Hills, MI (US); Shaun Tate, Grand Blanc, MI (US); Michael Eastman, Petersburg, OH (US)

(73) Assignee: SCHAEFFLER TECHNOLOGIES AG & CO. KG, Herzogenaurach (DE)

(21) Appl. No.: 16/419,397

(22) Filed: May 22, 2019

Related U.S. Application Data
(60) Provisional application No. 62/675,180, filed on May 23, 2018.

(51) Int. Cl. F16C 33/41; F16C 19/18; F16C 19/50

(52) U.S. Cl. CPC F16C 33/418; F16C 19/505; F16C 19/181

(57) ABSTRACT

Wheel bearings utilize two sets of tandem ball bearings. Each set of tandem ball bearings utilize a single cage that staggers the circumferential positions of balls in one row relative to balls in a second row. As a result of the staggering, the two rows can be closer together. This improves the wheel bearing stiffness relative to tilting without increasing the overall bearing dimensions.

### CROSS-REFERENCE TO RELATED APPLICATIONS

This application claims priority to U.S. Provisional Application 62/675,180 filed May 23, 2018, the entire disclosure of which is incorporated by reference herein.

### TECHNICAL FIELD

The present disclosure relates generally to vehicular wheel bearings. Specifically, the disclosure relates to an offset angular contact double row ball bearing with a single cage.

### BACKGROUND

Rolling bearings are widely used in various mechanical applications, including the automotive field. Tandem rolling bearings, a type of double row bearing, include two rows of rolling elements. The two rows are generally arranged in a stepped-manner, axially offset in relation to one another. These rows generally include cages for retaining and separating the rolling elements in the circumferential direction. A subset of this is tandem ball bearings where the rolling elements are balls. Tandem ball bearing assemblies can include a small and large rolling element subassembly. Each subassembly may include a cage and a plurality of the rolling elements.

Cages for separating rolling elements are typically made from plastic, for example, in an injection-molding process. Angular-contact ball bearings may be configured in a tandem arrangement. The two main types of cages currently used in rolling bearing assemblies are closed and open. Closed cages retain rolling elements in the circumferential direction and both axial directions. When installed in a bearing assembly, the rolling elements arranged in a closed cage are retained about a given axis by either the cage or the races of the rings. Open cages separate rolling elements in the circumferential direction and retain the rolling elements on one axial side.

### SUMMARY

A wheel bearing assembly includes an inner ring, an outer race, four rows of balls, and two cages. The outer race may be adapted for fixation to non-rotating vehicle structure and the inner ring may be adapted for fixation to a vehicle wheel. The inner ring may include a first inner race for the first and second rows of balls and a second inner race for the third and fourth rows of balls. The second inner race may be axially retained with respect to the first inner race by a lip of the first inner race bent outwardly. The first inner race may include a flange defining a set of holes adapted for mounting a vehicle wheel.

The first and second rows of balls separate the inner ring from the outer race radially and in a first axial direction. The second row is offset radially and axially from the first row. The third and fourth rows of balls separate the inner ring from the outer race radially and in a second axial direction opposite the first axial direction. The fourth row is offset radially and axially from the third row. The first cage circumferentially positions balls of the first and second rows relative to one another such that the balls of the first row are circumferentially staggered relative to the balls of the second row. The second cage circumferentially positions balls of the third and fourth rows relative to one another such that the balls of the third row are circumferentially staggered relative to the balls of the fourth row. Balls of the first through fourth rows have first through fourth axial positions, first through fourth radial positions, and first through fourth radii respectively. The first radial and axial positions may be separated from the second radial and axial positions by a distance less than a sum of the first and second radii. Similarly, the third radial and axial positions may be separated from the fourth radial and axial positions by a distance less than a sum of the third and fourth radii.

A bearing includes inner and outer rings, a bearing cage, and two sets of rolling elements. The bearing cage includes a central ring and two sets of axial projections. The first set of axial projections extend from the central ring to define a first set of pockets. The second set of axial projections extend from the central ring opposite the first set of axial projections to define a second set of pockets. The first set of rolling elements is disposed in the first set of pockets. The second set of rolling elements is disposed in the second set of pockets. The first and second sets of pockets are offset from one another in a circumferential direction such that centers of the first and second sets of rolling elements are staggered in the circumferential direction. The first set of rolling elements may be larger than the second set of rolling elements. The first and second sets of pockets may each be equally circumferentially spaced. The first and second sets of pockets may be offset such that centers of the first set of rolling elements are circumferentially located half-way between two adjacent rolling elements in the second set of rolling elements. The first and second sets of pockets may be configured such that the first set of rolling elements axially overlap with the second set of rolling elements. The bearing may be a tandem ball bearing. The inner and outer rings may each include raceways for the first and second sets of rolling elements.

A bearing assembly includes inner and outer races, first and second rows of balls, and a cage. The first and second rows of balls separate the inner race from the outer race. The second row is offset radially and axially from the first row. The cage circumferentially positions balls of the first and second rows relative to one another such that the balls of the first row are circumferentially staggered relative to the balls of the second row. Each of the first and second rows of balls may contact the inner and outer races as two-point angular contact bearings separating the inner race from the outer race in a radial direction and an axial direction. The balls of the first and second rows have first and second axial positions, first and second radial positions, and first and second radii, respectively. The first radial and axial positions may be separated from the second radial and axial positions by a distance less than a sum of the first and second radii.

### BRIEF DESCRIPTION OF THE DRAWINGS

FIG. 1 is a cross-section of a first wheel bearing assembly having two sets of double row angular contact ball bearings with separate bearing cages.

FIG. 2 is a cross-section of a second wheel bearing assembly having two sets of double row angular contact ball bearings, each set having a single bearing cage.

FIG. 3 is a perspective view of a bearing cage suitable for use in the wheel bearing assembly of FIG. 2.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

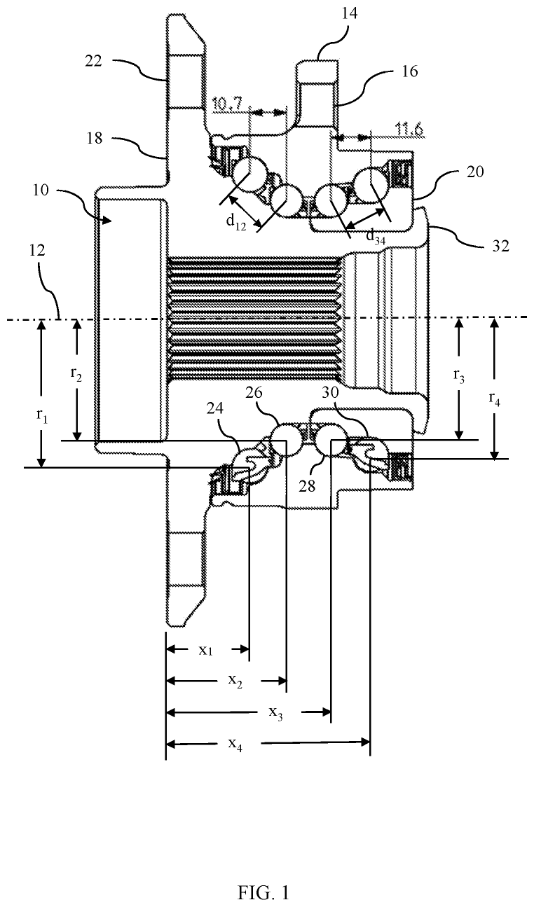

FIG. 1 illustrates a first wheel bearing assembly. Since the wheel bearing is mostly axisymmetric, many features appear in both the top half and bottom half of FIG. 1. A polar coordinate system in used to discuss various features. Positions, distance, and forces parallel to the axis 12 (left or right in FIG. 1) are referred to as axial positions, axial distances, and axial forces. Positions, distances, and forces perpendicular to axis 12 (up or down in FIG. 1) are referred to as radial positions, radial distances, and radial forces. Angular positions or distances around the axis 12 are referred to as circumferential positions or circumferential distances.

The wheel bearing assembly includes an inner ring 10 supported to rotate about axis 12. The wheel bearing assembly includes an outer race 14 that is non-rotationally fixed to vehicle structure. “Non-rotationally fixed,” in this context, means that it does not rotate about axis 12. It may translate as part of a vehicle suspension system and rotate through a limited range about a vertical axis as part of a vehicle steering system. The axis of rotation 12 is positioned relative to outer race 14. For example, outer race may be bolted to vehicle structure via hole 16. In alternative embodiments, the inner ring may be non-rotationally fixed to vehicle structure and the outer race may rotate about axis 12.

Inner ring 10 includes flanged first inner race 18 and second inner race 20. Flanged inner race 18 includes features, such as hole 22 for mounting a vehicle wheel. A driving shaft may engage a spline of the inner ring exerting torque to propel the vehicle. Two rows of balls, 24 and 26, separate the first inner race 18 from outer race 14. The balls contact the inner race and outer race at an angular such that they separate the first inner race 18 from the outer race 14 both radially and in one axial direction. Flanged inner race 18 may be locally hardened in the vicinity of the balls. Another two rows of balls, 28 and 30, separate second inner race 20 from outer race 14. Similarly, the balls 28 and 30 contact the second inner race and outer race at an angular such that they separate the second inner race 20 from the outer race 14 both radially and in an opposite axial direction. Second inner race 20 is retained with respect to flanged first race 18 by bending a lip 32 outwardly after assembly.

Collectively, the balls position inner ring 10 relative to outer race 14 both radially and axially. Substantial radial and axial forces may be transmitted between inner ring 10 and outer race 14 via the balls. Specifically, the weight of the vehicle results in radial forces. Inner ring 10 is free to rotate about axis 12 with minimal parasitic drag. Having four rows of balls as opposed to two rows of balls greatly increases the load capability of the wheel bearing assembly with respect to radial loads. The wheel bearing assembly also resist tilting moments about a vertical axis and/or an axis into the page. Resistance to tilting is predominantly provided by the outer rows of balls 24 and 30 because the distance between inner rows 26 and 28 is relatively small, limiting the available moment arm.

The centers of the balls of the first row of balls, 24, have an axial position, x₁, relative to a datum and a radial position, r₁, relative to the axis of rotation 12. Similarly, the centers of the balls of the second row of balls, 26, have an axial position, x₂, and a radial position, r₂. The distance between these rows of balls is d₁₂. These dimensions are related by the formula (x₂−x₁)²+(r₁−r₂)²=d₁₂². Note that the distance between a center of a particular ball in the first row and a particular ball in the second row may be greater than d₁₂ if the two balls are at different circumferential positions. In the wheel bearing assembly of FIG. 1, the balls of each row are retained circumferentially by separate cages. Each cage determines the relative circumferential positions of balls within that row. However, the relative circumferential positions of the two cages are not necessarily constrained. Balls of row 24 may or may not be aligned with balls of row 26. The distance d₁₂ must be larger than the sum of the radii of the respective balls to ensure that they do not touch if they become aligned.

Similarly, the centers of the balls of the third row of balls, 28, have an axial position, x₃, and a radial position, r₃. The centers of the balls of the fourth row of balls, 30, have an axial position, x₄, and a radial position, r₄. The distance between the third row and the fourth rows is d₃₄. These dimensions are related by the formula (x₄−x₃)²+(r₄−r₃)²=d₃₄².

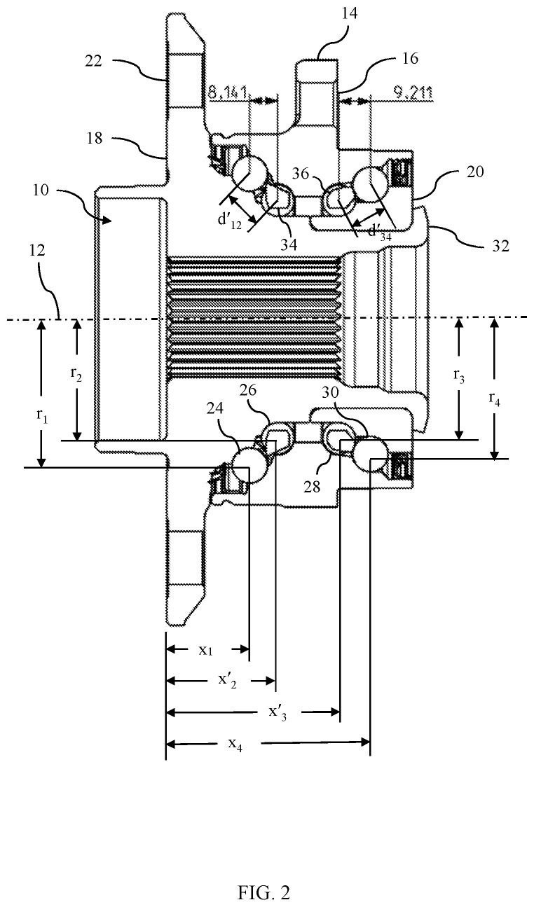

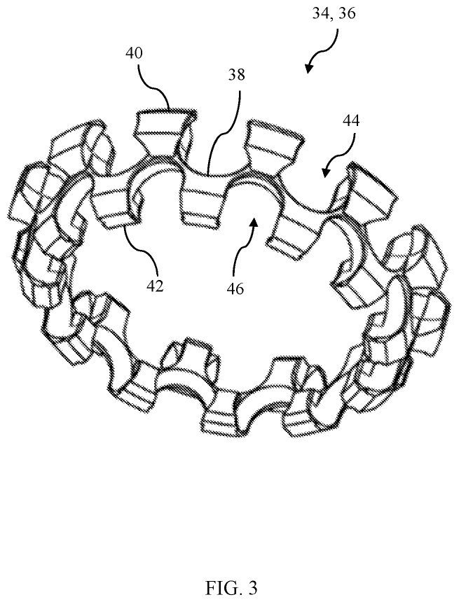

FIG. 2 illustrates a second wheel bearing assembly. Components that are common to the wheel bearing assemblies of FIGS. 1 and 2 are labelled with the same reference numbers. In the wheel bearing assembly of FIG. 2, balls of the first row 24 and balls of the second row 26 are circumferentially retained by a single cage 34. Similarly, balls of the third row 28 and balls of the fourth row are retained by a single cage 36. A cage suitable for retaining two offset rows of balls is illustrated in FIG. 3. The cage includes a central ring 38, a first set of axial projections 40, and a second set of axial projections 42. The central ring and first set of axial projections 40 define a first set of pockets 44. The first set of pockets circumferentially positions the balls of an outer row, 24 or 30, relative to one another. Similarly, the central ring and second set of axial projections 42 define a second set of pockets 46. The second set of pockets circumferentially positions the balls of an inner row 26 or 28, relative to one another and relative to balls of the outer row. The balls of the inner row are staggered relative to the balls of the outer row. In other words, the circumferential position of each ball of the inner row is between the circumferential positions of the two nearest balls of outer row. In this case, the circumferential position of each ball of the inner row is midway between the circumferential positions of the two nearest balls of outer row. This circumferential staggering permits the rows to be axially and/or radially closer together. The central ring may be axially wavy such that it winds between pockets of the inner row and pockets of the outer row.

In the wheel bearing assembly of FIG. 2, the axial positions of the inner rows of balls, x′₂ and x′₃, have been moved outward relative to the corresponding positions in the wheel bearing assembly of FIG. 1. As a result, the distances between rows, d′₁₂ and d′₃₄, are also smaller than in the wheel bearing assembly of FIG. 1. Due to the staggering, it is not necessary for distances d′₁₂ and d′₃₄ to exceed the sum of the radii of the respective balls. The radii of the balls of the inner sets 26 and 28 may be smaller than the radii of the balls of the outer sets 24 and 30. The axial distance between the inner rows, x′₃−x′₂, is larger than the corresponding distance in the wheel bearing assembly of FIG. 1. Therefore, the inner rows contribute more to resisting tilting moments increasing the total resistance to tilting.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

What is claimed is:

1. A wheel bearing assembly comprising:
an inner ring;
an outer race;
first and second rows of balls separating the inner ring from the outer race radially and in a first axial direction, the second row offset radially and axially from the first row;
third and fourth rows of balls separating the inner ring from the outer race radially and in a second axial direction opposite the first axial direction, the fourth row offset radially and axially from the third row;
a first cage circumferentially positioning balls of the first and second rows relative to one another such that the balls of the first row are circumferentially staggered relative to the balls of the second row; and
a second cage circumferentially positioning balls of the third and fourth rows relative to one another such that the balls of the third row are circumferentially staggered relative to the balls of the fourth row.

2. The wheel bearing assembly of claim 1 wherein:
each ball of the first row has a first axial position, a first radial position, and a first radius;
each ball of the second row has a second axial position, a second radial position, and a second radius; and
the first radial and axial positions are separated from the second radial and axial positions by a distance less than a sum of the first and second radii.

3. The wheel bearing assembly of claim 2 wherein:
each ball of the third row has a third axial position, a third radial position, and a third radius;
each ball of the fourth row has a fourth axial position, a fourth radial position, and a fourth radius; and
the third radial and axial positions are separated from the fourth radial and axial positions by a distance less than a sum of the third and fourth radii.

4. The wheel bearing assembly of claim 1 wherein the outer race is adapted for fixation to non-rotating vehicle structure and the inner ring is adapted for fixation to a vehicle wheel.

5. The wheel bearing assembly of claim 1 wherein the inner ring comprises:
a first inner race for the first and second rows of balls; and
a second inner race for the third and fourth rows of balls, the second inner race axially retained with respect to the first inner race by a lip of the first inner race bent outwardly.

6. The wheel bearing assembly of claim 5 wherein the first inner race includes a flange defining a set of holes adapted for mounting a vehicle wheel.

7. A bearing, comprising:
an inner ring;
an outer ring;
a bearing cage including:
a central ring;
a first set of axial projections extending from the central ring and defining a first set of pockets; and
a second set of axial projections extending from the central ring opposite the first set of axial projections, the second set of axial projections defining a second set of pockets;
a first set of rolling elements disposed in the first set of pockets; and
a second set of rolling elements disposed in the second set of pockets; and
wherein the first and second sets of pockets are offset from one another in a circumferential direction such that centers of the first and second sets of rolling elements are staggered in the circumferential direction.

8. The bearing of claim 7, wherein the first set of rolling elements is larger than the second set of rolling elements.

9. The bearing of claim 7, wherein the first and second sets of pockets are each equally circumferentially spaced.

10. The bearing of claim 9, wherein the first and second sets of pockets are offset such that centers of the first set of rolling elements are circumferentially located half-way between two adjacent rolling elements in the second set of rolling elements.

11. The bearing of claim 7, wherein the first and second sets of pockets are configured such that the first set of rolling elements axially overlap with the second set of rolling elements.

12. The bearing of claim 7, wherein the bearing is a tandem ball bearing.

13. The bearing of claim 7, wherein the inner ring and the outer ring each include a raceway for the first set of rolling elements and a raceway for the second set of rolling elements.

14. A bearing assembly comprising:
an inner race;
an outer race;
first and second rows of balls separating the inner race from the outer race, the second row offset radially and axially from the first row; and
a cage circumferentially positioning balls of the first and second rows relative to one another such that the balls of the first row are circumferentially staggered relative to the balls of the second row.

15. The bearing assembly of claim 14 wherein each of the first and second rows of balls contact the inner and outer races as two-point angular contact bearings separating the inner race from the outer race in a radial direction and an axial direction.

16. The bearing assembly of claim 15 wherein:
each ball of the first row has a first axial position, a first radial position, and a first radius;
each ball of the second row has a second axial position, a second radial position, and a second radius; and
the first radial and axial positions are separated from the second radial and axial positions by a distance less than a sum of the first and second radii.
